(19) United States
(12) Patent Application Publication
(10) Pub. No.: US 2026/0102695 A1
(43) Pub. Date: Apr. 16, 2026

(54) An Ergonomic Game Controller Extended Thumbstick Cover and a Method of Producing the Same

(71) Applicant: Setex Technologies, Inc., Pittsburgh, PA (US)

(72) Inventors: Patrick J. Clarkson, Pittsburgh, PA (US); Paul Samuel Glass, Pittsburgh, PA (US); Aimee L. Deluca, Pittsburgh, PA (US); Burak Aksak, Pittsburgh, PA (US)

(73) Assignee: Setex Technologies, Inc., Pittsburgh, PA (US)

(21) Appl. No.: 19/117,190

(22) PCT Filed: Sep. 29, 2023
(86) PCT No.: PCT/US2023/034085

§ 371 Date: Mar. 31, 2025

Related U.S. Application Data
(60) Provisional application No. 63/411,379, filed on Sep. 29, 2022.

(51) Int. Cl. A63F 13/24; A63F 13/98

(52) U.S. Cl. CPC A63F 13/24; A63F 13/98

(57) ABSTRACT

A game controller extended thumbstick cover has a compliant base to affix the extended thumbstick cover to the controller thumbstick and a compliant cover to contact the thumb of the user of the game controller. Friction-modifying elements on the compliant cover provide enhances grip and can further reduce repetitive strain injuries for user's of controllers having a thumbstick.

### CROSS-REFERENCE TO RELATED APPLICATIONS

This application claims priority to U.S. Provisional Application Ser. No. 63/411,379, filed Sep. 29, 2022, which is incorporated by reference herein in its entirety.

### STATEMENT REGARDING FEDERALLY SPONSORED RESEARCH

Not applicable.

### BACKGROUND OF THE INVENTION

The invention relates generally to a consumer product which modifies the height and surface friction of console and PC game controller thumbsticks. More specifically, the invention relates to a game controller extended thumbstick cover made from two or more materials which are compliant in nature, resulting in reduced stresses at the controller/thumb interface, reduced reaction forces transmitted to the user musculoskeletal system, and more comfortable experience for game controller users.

Of the estimated 2.5 billion gamers worldwide, many use game controllers which include one or more elevated thumbsticks. These are components of the controller that when manipulated, generally with a thumb, control an element of the on-screen game. Most game controllers consist of two thumbsticks, one of which is manipulated with the left thumb, and one of which is manipulated with the right thumb.

Many game controller users use their devices for hours on end, which has resulted in an increase in repetitive strain injuries from gaming such as carpal tunnel syndrome, tendonitis, carpometacarpal joint arthritis, and more. These injuries may require extensive therapy, and in some cases, invasive surgery to heal. Such injuries have increased the demand for more ergonomic products which minimize the likelihood of repetitive strain injuries.

Previously, thumbstick covers have been commercialized which consist of at least two elements: (1) a rigid base designed to affix to the controller thumbstick, and (2) a softer cover designed for users to rest their thumbs on and actuate the thumbstick, such as the assembly show in U.S. Pat. No. 7,993,203. When thumbstick extenders with rigid bases are actuated with lateral force to control the on-screen element of the game, they hit a rigid stop at the limit of rotation of the thumbstick, resulting in a force being transmitted back through the rigid base to the compliant cover, and to the user's thumb, fingers, and wrist. This repetitive reaction force transmission back through the user's musculoskeletal system may play a critical role in the onset of repetitive strain injuries which beleaguer gamers.

### BRIEF SUMMARY

One embodiment of the present invention is an apparatus developed to improve the comfort and performance of game controller users which consists of two elements. The first element is a compliant base which is designed to fit over the thumbstick element of a game controller. The second element is a compliant top surface which is designed to fit over the compliant base and come into contact with the user's thumb. By manipulating the compliant thumbstick extender during gaming, the user experiences reduced stresses at the thumb/device interface, putting reduced strain on their musculoskeletal system, minimizing the likelihood of repetitive strain injuries. In certain embodiments of the invention, additional friction-enhancing features are present at the top surface of the thumbstick extender to improve the grip of the user's thumb in contact with the device.

### BRIEF DESCRIPTION OF THE SEVERAL VIEWS OF THE DRAWINGS

FIG. 1 is an assembly drawing of an extended thumbstick cover comprising two elements.

FIG. 2 is the comparison of the output of a numerical model of a thumbstick cover consisting of two compliant elements (left) and the output of a numerical model of a thumbstick cover consisting of one rigid and one compliant element (right) under 10 N compressive loads.

FIG. 3 is the comparison of the output of a numerical model of a thumbstick cover consisting of two compliant elements (left) and the output of a numerical model of a thumbstick cover consisting of one rigid and one compliant element (right) under 5 N compressive load and 5 N lateral load.

FIG. 4 is a detailed view of the thumbstick cover showing the enhanced friction surface.

FIG. 5 is a magnified view of the enhanced friction surface.

### DETAILED DESCRIPTION

In one embodiment, a thumbstick extender comprises a compliant base 101 to affix the extender assembly 100 to the game controller thumbstick and a compliant cover 102, which engages the compliant base 101 and serves as the interface with a user's thumb. The extender assembly 100 reduces the stress present at the device/thumb interface (and the corresponding reaction forces transmitted to the user) to improve user comfort and minimize the likelihood of repetitive strain injuries when gaming. The assembly 100 can be used on controllers for video games, drones, remote-controlled vehicles, other hand-held controllers having a thumbstick, and similar devices intended to be manipulated with a user's fingers.

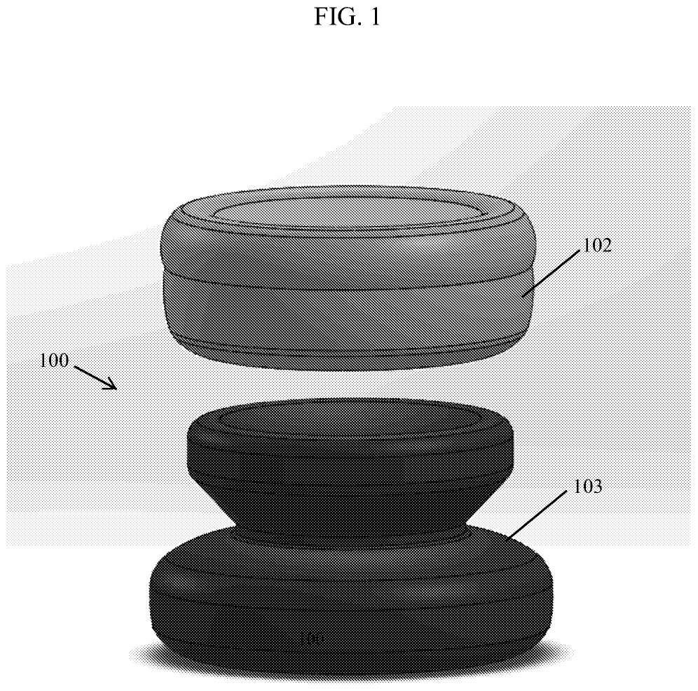

In the example embodiment shown in FIG. 1, the extended thumbstick cover assembly 100 comprises a compliant base 101 designed to affix the extended thumbstick assembly 100 to the game controller thumbstick and a compliant cover 102 to be manipulated by the user's thumb. The compliant cover 102 can be affixed to the compliant base 101 through a friction fit, adhesives, co-molding, or other methods. The surface of the cover 102 may include an enhanced friction surface 103, such as micro- and nano-sized fibers. In several embodiments, both the base 101 and the cover 102 are produced using compliant elastomeric materials using conventional high throughput elastomer manufacturing processes such as those described below, but not limited to:
A. Injection molding: Injection over molding, Co-injection molding, Gas assist injection molding, Tandem injection molding, Ram injection molding, Micro-injection molding, Vibration assisted molding, Multiline molding, Counter flow molding, Gas counter flow molding, Melt counter flow molding, Injection-compression molding disks, Continuous injection molding, Reaction injection molding (Liquid injection molding, Soluble core molding, Insert molding), and Vacuum Molding;
B. Compression molding: Transfer molding, and Insert molding;
C. Thermoforming: Pressure forming;
D. Casting: Encapsulation, Potting, and impregnation;

In one embodiment the compliant base 101 and compliant cover 102 are made using thermoplastic elastomers. In one embodiment, the compliant base 101 is produced using a material with Shore A hardness of 55A and the compliant cover 102 is produced using a material with Shore A hardness 45A. In alternative embodiments, the base 101 may have a hardness ranging from about 45A to 65A. If the low end of the range, the base 101 may be too soft and fail to interface with the thumbstick in a secure manner. At the high end of the range, the base 101 may be too hard and not provide the benefits of enhanced feel and improved gameplay. Similarly, the cover 102 may have a hardness in a range of 30A to 40A. The base 101 and cover 102 may be produced from a range of materials, including polymers, elastomers, thermoset plastics, and other similar materials that have a hardness within the range specified. In another alternative embodiment, the base 101 and cover 102 are produced from compliant silicones. The range of hardness also offers variations to suit user preferences. With an extended cover, the forces experienced by a user when hitting the limit in the range of motion of the thumbstick is reduced because the stem 104 of the compliant base 101 is able to flex. Some users may prefer a stiffer stem 104 for increased control, while others prefer the comfort of a softer stem 104.

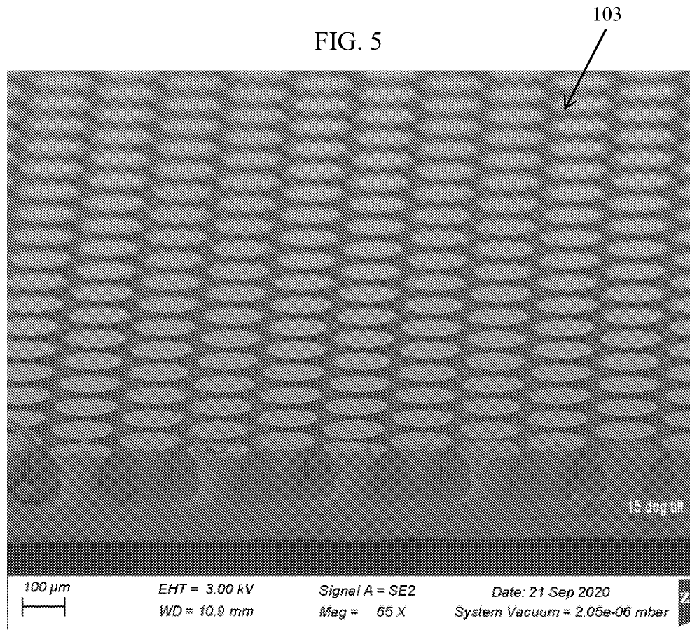

In one embodiment, the compliant cover 102 is covered with microstructured features 103 which enhance the coefficient of friction to skin when compared with unstructured compliant covers 102 made from the same resin. The friction modified features 103, in one embodiment, comprises micro- and nano-sized pillars or fibers having expanded, mushroom-shaped tips. FIG. 4 shows an image of a cover 102 with the friction modifying features 103. FIG. 5 is a magnified view of the features 103, with the size scale shown at 100 μm. With the use of friction features 103, the local hardness at the interface between the user's thumb and the cover 102 is lowered, as the fibrous features 103 offer compliance in addition to the bulk compliance of the cover's material. The increased friction can further reduce the strain experienced by a user as less force is required to maintain the thumb's position on the controller. Further, the hardness of the material can be further adjusted within the range to account for the increased local compliance and increased grip.

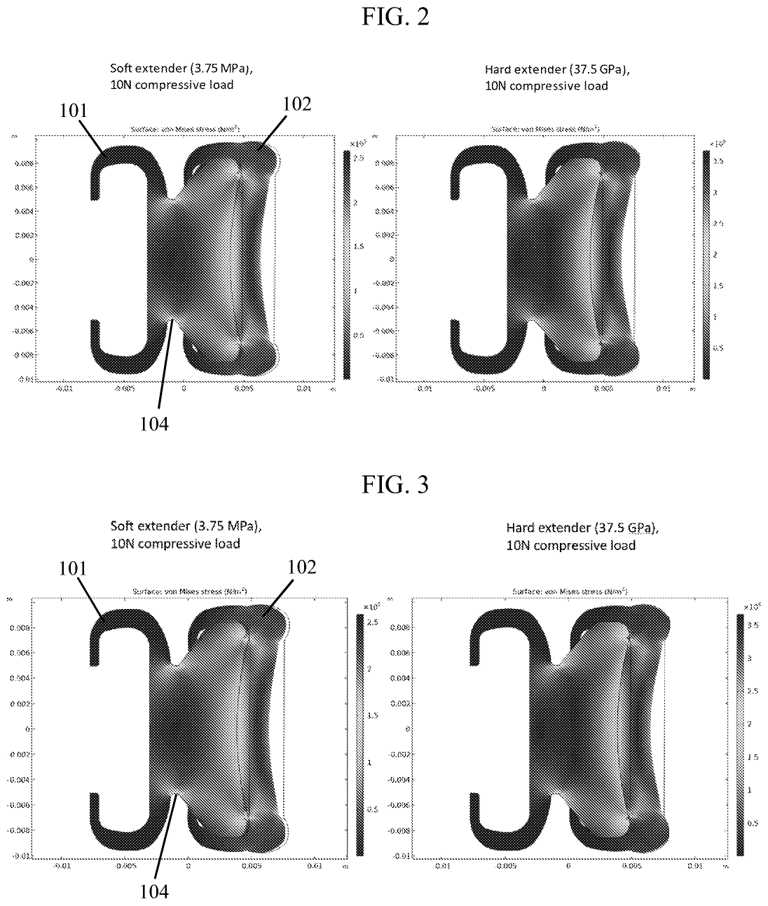

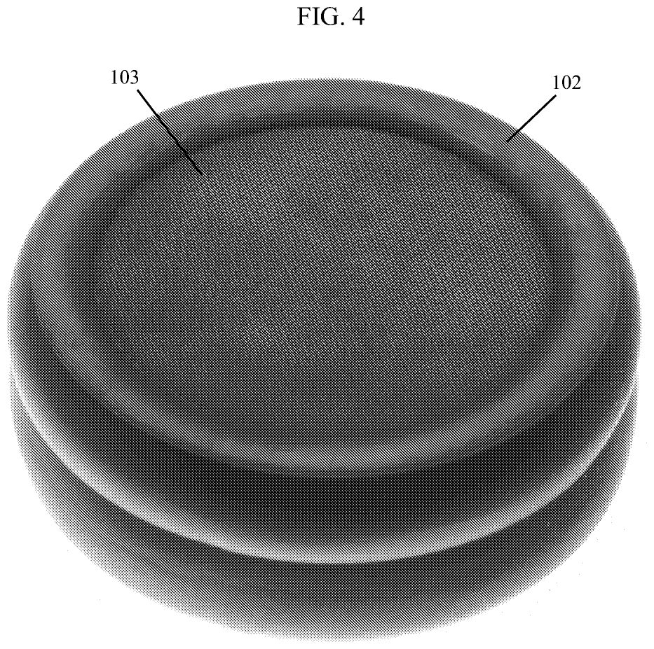

As shown in FIG. 1, the base 101 has an opening that is adapted to match the end of the controller thumbstick. To install the extended cover assembly 100, the opening of the base 101 is stretched over the controller thumbstick and held in place via a mechanical interference fit. By stretching the base 101 over the thumbstick, a secure connection is made between the thumbstick and base 101 despite the compliant material used for the base 101. The fit is further enhanced in the embodiment shown in FIG. 1 because the base 101 completely surrounds the thumbstick and provides a large interface area, particularly when compared to covers that attach via multiple prongs. Stated differently, the base 101 circumferentially engages the thumbstick, forming an interrupted interface between the base 101 and thumbstick. As further shown in FIGS. 2-3, a cavity on the bottom side of the base 101 substantially matches a profile of the controller thumbstick, increasing engagement between the base 101 and thumbstick. The cover 102 has a similar opening on its bottom side and is adapted to slide over the distal end of the base 101, or the end opposite the end engaged to the thumbstick. In an alternative embodiment, the assembly 100 is a monolithic unit with the base 101 and cover 102 formed together, yet from separate materials. A monolithic assembly 100 can be manufactured using insert injection molding or similar molding techniques where two different types of materials are used in the product. In this alternative embodiment, the cover 102 would still have a lower hardness than the base 101, despite being a unitary assembly 100.

FIG. 2 and FIG. 3 show the results of numerical analyses of two different extended thumbstick cover assemblies 100. These analyses were conducted using COMSOL Multiphysics 6.0 structural mechanics and CAD import modules. The model was setup using a linear elastic model with all of the materials having a Poisson's ratio of 0.3. The base 101 had an elastic modulus of 3.75 MPa and the cover had an elastic modulus of 1.47 MPa, which are commensurate with the materials identified above. For the purposes of this analysis, a rigid base was modeled having an elastic modulus of 37.5 GPa. In the lateral deflection simulations, both the lateral and normal forces were applied simultaneously on the top surface of the compliant cover 102. They were applied uniformly in terms of N/m\hat{ }2 (i.e. if 5 N total force was applied, it was applied uniformly over the top surface in the magnitude 5 N/[top surface area]). Lateral force was set to 7.5 N and normal force to 5 N. Pressure distribution simulations were used to simulate the normal force applied by the thumb. A Hertzian contact model, aimed at stimulating the contact of a 10 mm diameter spherical probe with the thumb cover 102, was used. This method was used to better model the contact of the thumb with the compliant cover 102. In this model, a normal pressure distribution which follows,

$$p = {{p}_{o} ( 1 - \frac{r}{0.01} )}^{0.5} ,$$

was applied. Here r is the radial distance from the center of the compliant cover 102, and pₒ is the maximum pressure on the compliant cover 102. Maximum pressure pₒ depends on the magnitude of the compressive force in that

$${p}_{o} = 3 F / ( 2 π ( 0.0 {1}^{2} ) )$$

Here, we used F=7 N for both the compliant base 101 and rigid base simulations.

In the left of both figures, we show the results of thumbstick cover assemblies 100 produced from a compliant base 101 with Young's modulus of 3.75 MPa and a compliant cover 102 with Young's modulus of 1.47 MPa, whereas in the right of both figures the results of thumbstick cover assemblies 100 produced from a rigid base with Young's modulus of 37.5 GPa and a compliant cover with Young's modulus 1.47 MPa are shown. In FIG. 2, the results are shown of an analysis where the assemblies 100 were subjected to a compressive load of 10 N. In the case where both the base 101 and cover 102 elements are compliant (left), it is evident that the maximum von Mises stress felt at the perimeter of the thumbstick extender cover 102 is 2.5×10⁵ N/m² whereas in the case where the base 101 is rigid and the cover 102 is compliant (right), the maximum von Mises stress felt at the perimeter of the thumbstick extender cover 102 is 3.5×10⁵ N/m², a percent increase of 40% over the fully compliant version of the assembly 100. von Mises stress can be used to analyze the yield characteristics of the compliant material under complex loading conditions.

In FIG. 3, the results are shown of an analysis where the assemblies 100 were subjected to a compressive load of 5 N and a lateral load of 5 N. In the case where both the base 101 and cover 102 elements are compliant (left), the maximum von Mises stress felt at the perimeter of the thumbstick extender cover 102 is 0.25×10⁶ N/m² whereas in the case where the base 101 is rigid and the cover 102 is compliant (right), the maximum von Mises stress felt at the perimeter of the thumbstick extender cover 102 is 1×10⁶ N/m², a percent increase of 300% over the fully compliant version of the assembly 100.

Because the thumbstick element of a game controller is designed to transmit lateral motion to the game system, it is reasonable to assume lateral loads will be present during the majority of game play. By using all compliant elements, this significant reduction in von Mises stress at the thumb/device interface results in a corresponding significant reduction in the reaction force transmitted to the user's musculoskeletal system, minimizing the strain on the user's body. By doing so, the invention results in a more comfortable, ergonomic experience and reduces the likelihood of repetitive strain injuries that user's may experience from long game play.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. In particular, one or more features in any of the embodiments described herein may be combined with one or more features from any other embodiments described herein.

Protection may also be sought for any features disclosed in any one or more published documents referred to and/or incorporated by reference in combination with the present disclosure.

What is claimed is:

1. A cover assembly for a controller thumbstick comprising:
a base having a proximal end and a distal end, wherein the proximal end is adapted to engage a thumbstick of a hand-held controller;
a cover disposed on the distal end of the base;
wherein the cover has a hardness less than a hardness of the base.

2. The cover assembly of claim 1, wherein the base and the cover are separate components.

3. The cover assembly of claim 1, wherein the base has a hardness of about 55A.

4. The cover assembly of claim 1, wherein the cover has a hardness of about 45A.

5. The cover assembly of claim 1, further comprising:
a plurality of friction-modifying features disposed on a surface of the cover.

6. The cover assembly of claim 1, wherein the base has a cavity matching a profile of the thumbstick.

7. The cover assembly of claim 1, wherein the base circumferentially engages the thumbstick.
